(19) United States
(12) Patent Application Publication
(10) Pub. No.: US 2018/0126571 A1
(43) Pub. Date: May 10, 2018

(54) ORAL CARE AND GROOMING DEVICE

(71) Applicant: Leigh M. Rothschild, Miami, FL (US)

(72) Inventor: Leigh M. Rothschild, Miami, FL (US)

(21) Appl. No.: 15/725,718

(22) Filed: Oct. 5, 2017

Related U.S. Application Data
(60) Provisional application No. 62/405,299, filed on Oct. 7, 2016.

(51) Int. Cl. B26B 19/48; A61C 17/34; B26B 19/38

(52) U.S. Cl. CPC B26B 19/48; A61C 17/225; B26B 19/3846; A61C 17/34

(57) ABSTRACT

An oral care and grooming device is disclosed. The device comprises a head section and a body. The head section connects either to a detachable oral care head or a detachable grooming head. The detachable grooming head may comprise a trimmer, shaver, or an epilator. The body comprises a power source connected to a microcontroller, a motor, and a communication device. The microcontroller operates the motor and the communication device based on a position of a control switch. The detachable oral care head and the detachable grooming head moves along with a movement of the motor. The communication device may communicate usage details of the oral care and grooming device to a mobile application. The usage details may comprise date or time details, operation time, and an operation pattern of the oral care device and the grooming device. The usage details may also be transmitted to a remote server for further processing and storage.

### FIELD OF THE DISCLOSURE

The present disclosure is generally related to oral care devices and grooming devices and more particularly to electric toothbrush and shavers.

### BACKGROUND

A user uses multiple oral care and grooming products for maintaining a personal hygiene. A toothbrush, shaver, trimmer, and an epilator are a few of such products. After a defined number of usage cycles, the products or their parts need to be replaced for effective working of the products. For example, shaving heads of a shaver needs to be changed after certain usages. Further, a toothbrush needs to be completely replaced after a certain period.

Electric shavers and electric toothbrushes are widely available these days. For their effective working, a user may regularly need to assess a condition of a shaving head or a shaving blade of the shaver. Based on the condition, the user may need to change the head or the shaving blade of the shaver. In case of an electric toothbrush, a complete change is required after bristles of the electric toothbrush deform in shape. Thus, conditions of both the products need to be monitored continuously by the user. There does not exist a way to inform the user about changing the toothbrush and the shaving head of the shaver.

Another problem associated with the grooming devices is inability of their interchange, for serving their purpose. For example, a toothbrush cannot serve the purpose of a shaver. They are used separately and cannot replace each other's function. Thus, it becomes necessary to have each of these products.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, an oral care and grooming device is provided. The oral care and grooming device comprises a head section. The head section is used to connect either a detachable oral care head or a detachable grooming head. The oral care and grooming device further comprise a body. The body comprises a power source connected to a microcontroller, a motor, and a communication device. The microcontroller operates the motor and the communication device based on a position of a control switch.

In one embodiment, sensors present on the oral care and grooming device gathers raw usage data. Further, an algorithm executed by the microcontroller determines usage details by processing the raw usage data. The usage details comprise date or time details, operation time, and an operation pattern of either the detachable oral care head or the detachable grooming head, whichever connected on the head section. The microcontroller may also record a date and time of mounting of the detachable oral care head and the detachable grooming head. Based on the date and time of installation and the operation time, the microcontroller may indicate to the user a time for replacement of the detachable oral care head or the detachable grooming head. The detachable grooming head and the detachable oral care head moves along with a movement of the motor. The communication device communicates usage details of the oral care and grooming device to a mobile application.

In another example embodiment, an oral care and grooming system is provided. The oral care and grooming system comprises a head section. The head section connects either a detachable oral care head or a detachable grooming head. The oral care and grooming system further comprises a body. The body comprises a power source connected to a microcontroller, a motor, and an indicating source. The microcontroller operates the motor and the communication device based on a position of a control switch. Sensors present on the microcontroller gathers raw usage data. An algorithm executed by the microcontroller determines usage details by processing the raw data. The usage details comprises date or time details, operation time, and an operation pattern of either the detachable oral care head or the detachable grooming head, whichever connected on the head section. The detachable oral care head and the detachable grooming head moves along with a movement of the motor. The indicating source comprises either of a display device and an audio device to inform a user about the usage details.

In another example embodiment, a method of using an oral care and grooming device is provided. The method comprises connecting either a detachable oral care head or a detachable grooming head on a head section. The method comprises changing position of a control switch for operating, by a microcontroller, a motor and a communication device. The detachable oral care head and the detachable grooming head moves along with movement of the motor. The method further comprises gathering raw usage data by using sensors present on the oral care and grooming device. The method further comprises determining usage details by an algorithm executed by a microcontroller. The usage details comprise day, time details, operation time, and an operation pattern of either the detachable oral care head or the detachable grooming head, whichever connected on the head section. The algorithm determines the usage details by processing the raw usage data. The method further comprises communicating, by a communication device, usage details of the oral care and grooming device to a mobile application.

Other systems, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of an oral care and grooming device 100, according to an embodiment.

FIG. 2 illustrates a flow diagram of a method of using an oral care and grooming device, according to an embodiment.

FIG. 3 illustrates a flow diagram of a method of using an oral care and grooming device, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

A microcontroller 106 may execute an algorithm stored in a memory. The microcontroller 106 may also be configured to transmit data to one or more other electronic devices or one or more remote servers. The microcontroller 106 may be replaced by a general purpose processor (e.g., INTEL microprocessors) and/or one or more special purpose processors (e.g., digital signal processors or Xilinx System On Chip (SOC) Field Programmable Gate Array (FPGA) processor). The microcontroller 106 may be configured to execute an algorithm to carry out any of the functions described in this description.

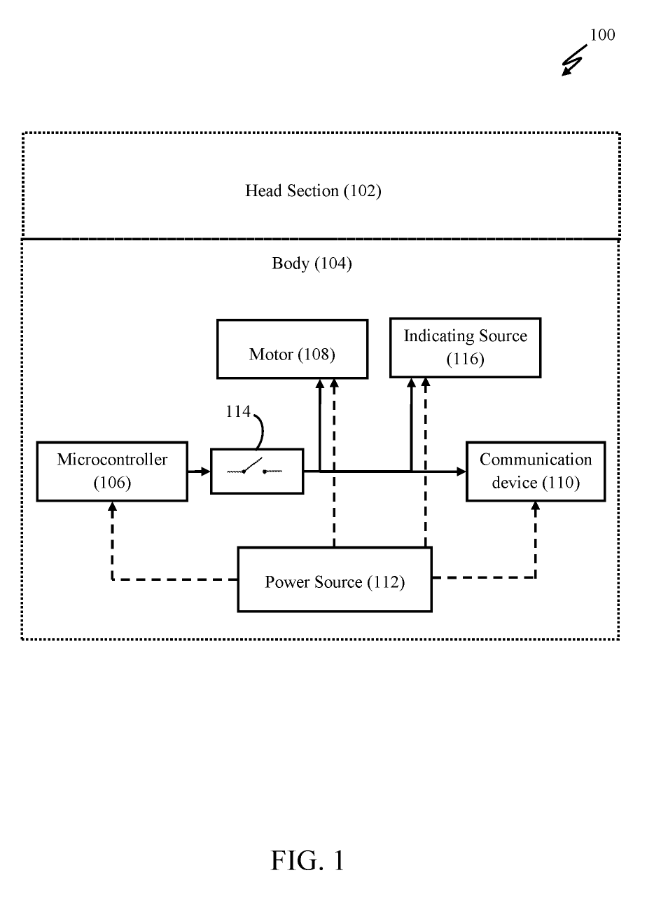

FIG. 1 illustrates a block diagram of an oral care and grooming device 100 in accordance with an embodiment of present disclosure. The oral care and grooming device 100 comprises a head section 102 and a body 104. The head section 102 may connect either with a detachable oral care head or a detachable grooming head. The head section 102 may connect with the detachable oral care head or the detachable grooming head using a suitable locking mechanism. The locking mechanism may include any of a snap fit, twist lock, socket lock, lever lock, or any other fastening mean.

In one embodiment, a detachable oral care head may be connected to the head section 102 of the oral care and grooming device 100. The detachable oral care head 102 may be a toothbrush head or a tongue cleaner. Further, based on a specification such as a model number of the toothbrush head, the toothbrush head may comprise hard bristles, soft bristles, or a mix of hard and soft bristles. Further, an edge of the toothbrush head may be of different types such as a flat, zigzag, and saw-tooth.

In another embodiment, a detachable grooming head may be connected to the head section 102 of the oral care and grooming device 100. The detachable grooming head may comprise either of a trimmer, shaver, and an epilator. Based on a need, a user may mount a particular detachable grooming head on the head section 102 of the oral care and grooming device 100. In one case, a man wishing to shave his beard may attach a shaver on the head section 102 of the oral care and grooming device 100. In another case, a woman wishing to clean her facial hairs may attach an epilator on the head section 102 of the oral care and grooming device 100.

In one embodiment, the oral care and grooming device 100 may comprise sensors to detect mounting of the detachable oral care head and the detachable grooming head. The sensors may identify a type and details of the detachable oral care head and the detachable grooming head being mounted on the head section 102. The details may comprise a model number and specification of the detachable oral care head and the detachable grooming head. The details may be stored in a memory of the oral care and grooming device 100.

In one embodiment, the oral care and grooming device 100 may be electrically powered. For deriving electrical power, the body 104 of the oral care and grooming device 100 may comprise a power source 112. The power source 112 may be connected to the microcontroller 106, a motor 108, and a communication device 110 present in the body 104 of the oral care and grooming device 100.

In one embodiment, the microcontroller 106 may be connected to the motor 108 through a control switch 114. A user may operate the control switch 114 to power on the oral care and grooming device 100. When the control switch 114 is closed, the microcontroller 106 may signal the motor 108 to work on different settings. The different settings may be related to functioning of the oral care and grooming device 100. The control switch 114 may be either of a soft switch, push button switch, and a rotary switch.

In one exemplary embodiment, the control switch 114 may be a rotary switch and may regulate a speed of operation of the motor 108, while a shaving head is attached with the oral care and grooming device 100. In another case, the control switch 114 may be a direction control switch and may decide a direction of movement of a brushing head being used on the oral care and grooming device 100. The brushing head may work in a right-left or up-down movement.

In one embodiment, raw usage data may be gathered using the sensors present on the oral care and grooming device 100. The raw usage data may be processed using an algorithm executed by the microcontroller 106 to determine usage details related to the oral care and grooming device 100. The microprocessor 106 may perform several mathematical computations while executing the algorithm for determining the usage details. The usage details may comprise date or time details, operation time, and an operation pattern of the detachable oral care head and the detachable grooming head, whichever connected on the head section 102. The usage details may be processed by the microcontroller 106 using the algorithm, to determine usage behaviour of a user.

In one exemplary embodiment, the brushing head may be used on the oral care and grooming device 100. The microcontroller 106 may record an installation date and time of the brushing head. On each usage, the microcontroller 106 may capture the date, time, and total usage timings related to the brushing head. The microcontroller 106 may store the usage in the memory or may send the usage details to the communication device 110 for remote transmission of data. The usage details may be transferred to a remote server for further processing of information.

In one embodiment, the communication device 110 may transmit the usage details to a mobile application on a smart phone used by a user. The smart phone may be using any of Android™, iOS™, or Windows™ operating systems. For an example, the usage details may be transmitted to Sony Xperia™ smart phone. A user operating the Sony Xperia™ smart phone may look at the usage details of the oral care and grooming device 100 operated by him.

The usage details may be transmitted to the smart phone using a communication technique selected from a group consisting of Bluetooth, Wi-Fi, Infrared, and over the network. In one case, an Enhanced Data rates for GSM Evolution (EDGE) or High Speed Packet Access (HSPA) technique may be used for transmitting the usage details over the network.

In one embodiment, the oral care and grooming device 100 may comprise an indicating source 116. The indicating source 116 may either be a display device or an audio device. The oral care and grooming device 100 may either display the usage details on the display device or may announce the usage details on the audio device of the oral care and grooming device 100. In one case, the user may refer to the date or time usage for knowing a last time when the oral care and grooming device 100 was used. The user may refer to the operation time to get an estimation of remaining charge and thus determining an amount of remaining time for which the oral care and grooming device 100 may operate. The user may refer to the usage pattern to increase a life of either of the detachable oral care head or the detachable grooming head.

In one embodiment, the microcontroller 106 may comprise a stored value of life of the brushing head. Since a new brushing head is installed on the head of the oral care and grooming device 100, the microcontroller 106 may use the algorithm to track usage of the brushing head. Further, the microcontroller 106 may also use to algorithm to determine a brushing habit of the user. Based on brushing habit of the user, the microcontroller 106 may determine an exact time for changing the brushing head. In one case, the microcontroller 106 of the oral care and grooming device 100 may determine a need of replacement of the detachable oral care head. The microcontroller 106 may determine the need by executing the algorithm. The algorithm may use several factors and may perform several mathematical computations for processing of the several factors to determine the need of replacement. The several factors may be selected from a group consisting of a date of installation, time of installation, number of usage sessions, usage time per session, total usage time, pressure applied by a user upon usage of the detachable oral head, age and sex of the user, product details of the oral care and grooming device, and a type of the detachable oral care head.

Just before expiry of the time, the microcontroller 106 may inform the user about replacement of the brushing head. In one case, an indicator may be used to indicate the user. The indicator may comprise at least one of a Light Emitting Device (LED), Liquid Crystal Display (LCD), vibrating element, and a speaker.

In one embodiment, the microcontroller 106 executing the algorithm may determine a need of servicing the oral care and grooming device 100. The microcontroller 106 may determine the need by the help of algorithm using the usage details. Further, the microcontroller 106 may inform the user about the need of servicing of the oral care and grooming device 100 using the indicating source 116. Upon knowing about the need of servicing, the user may service and clean motor, the detachable oral care head, and the detachable grooming head of the oral care and grooming device 100.

Based, on the indication provided by the indicator, the user may change any head installed on the oral care and grooming device 100. The indication may also inform a user about a type of the detachable oral care head and the detachable grooming head to be used based on his brushing and grooming habits. This may help the user to maintain an efficient functioning of the oral care and grooming device 100 by monitoring his brushing and grooming habits and timely replacement of heads of the oral care and grooming device 100. This device also avoids the user from the burden of carrying different grooming devices, and thus saves space while travelling.

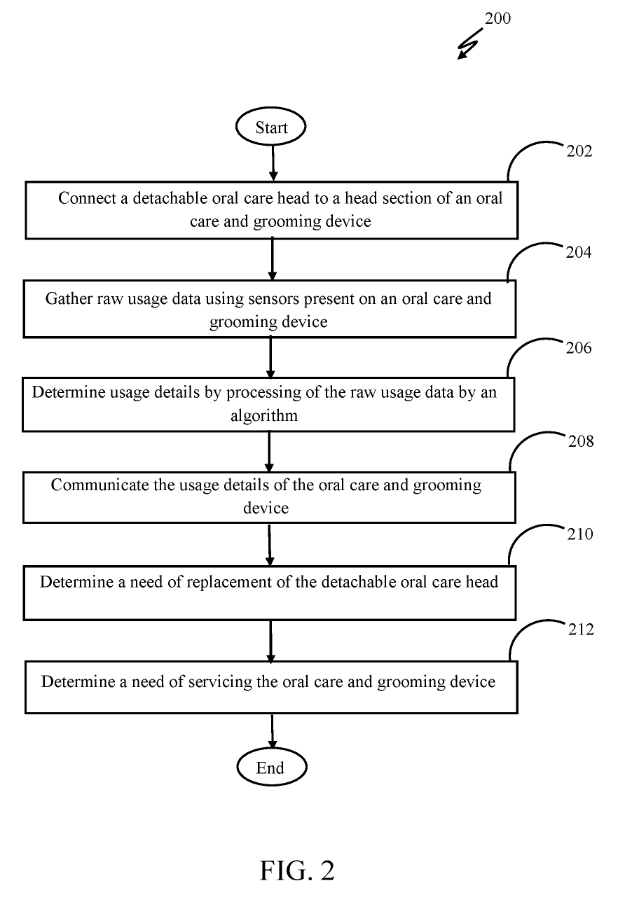

FIG. 2 illustrates a flowchart of method of using an oral care and grooming device, according to an embodiment. FIG. 2 comprises a flowchart 200 that is explained in conjunction with the elements disclosed in FIG. 1.

The flowchart 200 of FIG. 2 shows the architecture, functionality, and operation for marking objects present in an image. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 212.

At step 202, a detachable oral care head may be connected to a head section of an oral care grooming device.

At step 204, raw usage data may be gathered using sensors present on the oral care and grooming device.

At step 206, usage details of the oral care and grooming device may be determined. The usage details may be determined by processing the raw usage data. The usage details may comprise date or time details, operation time, and an operation pattern of the detachable oral care head.

At step 208, the usage details of the oral care and grooming device may be communicated. The usage details may be communicated to one of a remote server and a user.

At step 210, a need of replacement of the detachable oral care head may be determined. The need of replacement may be determined by a microcontroller upon executing an algorithm. To determine, the algorithm may use at least one factor of a date of installation, time of installation, number of usage sessions, usage time per session, total usage time, pressure applied by a user upon usage of the detachable oral care head, age and sex of the user, product details of the oral care and grooming device, and a type of the detachable oral care head.

At step 212, a need of servicing the oral care and grooming device may be determined. The need of servicing may be determined by the algorithm executed by the microcontroller. The algorithm may determine the need based on the usage details of the oral care head.

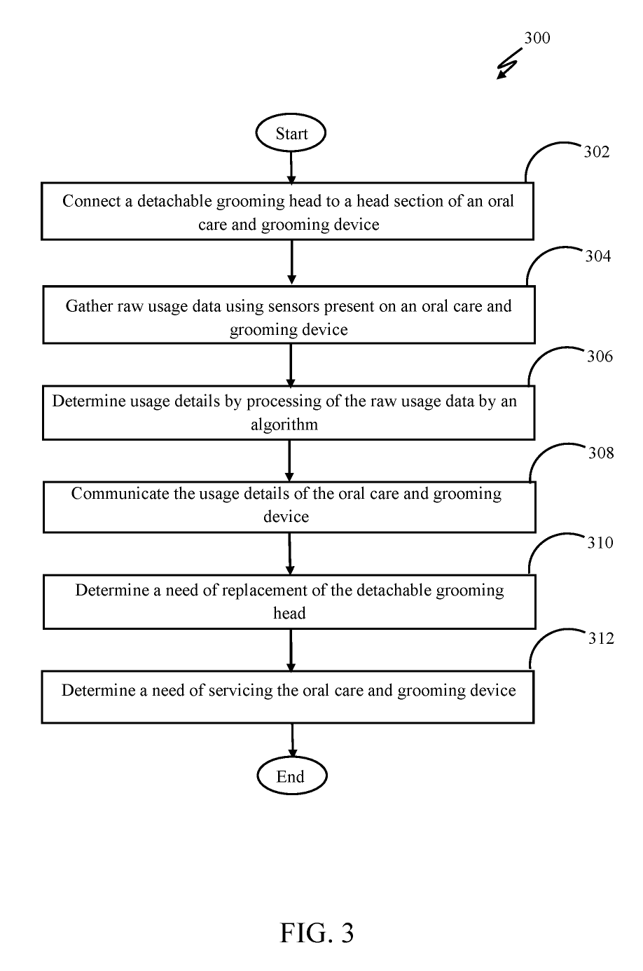

FIG. 3 illustrates a flowchart of method of using an oral care and grooming device, according to an embodiment. FIG. 3 comprises a flowchart 300 that is explained in conjunction with the elements disclosed in FIG. 1.

The flowchart 300 of FIG. 3 shows the architecture, functionality, and operation for marking objects present in an image. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 300 starts at the step 302 and proceeds to step 312.

At step 302, a detachable grooming head may be connected to a head section of an oral care grooming device.

At step 304, raw usage data may be gathered using sensors present on the oral care and grooming device.

At step 306, usage details of the oral care and grooming device may be determined. The usage details may be determined by processing the raw usage data. The usage details may comprise date or time details, operation time, and an operation pattern of the detachable oral care head.

At step 308, the usage details of the oral care and grooming device may be communicated. The usage details may either be communicated to one of a remote server and a user.

At step 310, a need of replacement of the detachable grooming head may be determined. The need of replacement may be determined by a microcontroller upon executing an algorithm. To determine, the algorithm may use at least one factor of a date of installation, time of installation, number of usage sessions, usage time per session, total usage time, pressure applied by a user upon usage of the detachable grooming head, age and sex of the user, product details of the oral care and grooming device, and a type of the detachable grooming head.

At step 312, a need of servicing the oral care and grooming device may be determined. The need of servicing may be determined by the algorithm executed by the microcontroller. The algorithm may determine the need based on the usage details of the grooming head.

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An oral care and grooming device comprising:
a head section for connecting either a detachable oral care head or a detachable grooming head; and
a body comprising:
a power source connected to a microcontroller, a motor, and a communication device,
wherein the microcontroller operates the motor and the communication device based on a position of a control switch,
wherein sensors present on the oral care and grooming device gather raw usage data,
wherein an algorithm executed by the microcontroller determines usage details by processing the raw usage data, and wherein the usage details comprise date or time details, operation time, and an operation pattern of either the detachable oral care head or the detachable grooming head, whichever connected on the head section,
wherein the detachable oral care head and the detachable grooming head moves along with a movement of the motor,
and wherein the communication device communicates the usage details to a mobile application.

2. The oral care and grooming device of claim 1, wherein the detachable grooming head comprises either of a trimmer, shaver, or epilator.

3. The oral care and grooming device of claim 1, further comprising the microcontroller determining, upon executing the algorithm, a need of replacement of the detachable oral care head.

4. The oral care device of claim 3, wherein the need of replacement of the detachable oral care head is determined by the algorithm executed by the microcontroller, wherein the algorithm uses one or more factors selected from a group consisting of a date of installation, time of installation, number of usage sessions, usage time per session, total usage time, pressure applied by a user upon usage of the detachable oral care head, age and sex of the user, product details of the oral care and grooming device, and a type of the detachable oral care head.

5. The oral care and grooming device of claim 1, further comprising the microcontroller determining upon executing the algorithm, a need of replacement of the detachable grooming head.

6. The oral care and grooming device of claim 5, wherein the need of replacement of the detachable grooming head is determined by the microcontroller upon executing the algorithm, wherein the algorithm uses one or more factors selected from a group consisting of a date of installation, time of installation, number of usage sessions, usage time per session, total usage time, pressure applied by a user upon usage of the detachable grooming head, age and sex of the user, product details of the oral care and grooming device, and a type of the detachable grooming head.

7. The oral care and grooming device of claim 1, further comprising informing a user, by an indicator, about a need of replacement of the detachable oral care head, wherein the indicator is at least one of a Light Emitting Diode (LED), Liquid Crystal Display (LCD), vibrating element, and a speaker.

8. The oral care and grooming device of claim 1, further comprising informing a user, by an indicator, about a need of replacement of the detachable grooming head, wherein the indicator is at least one of a Light Emitting Diode (LED), Liquid Crystal Display (LCD), vibrating element, and a speaker.

9. The oral care and grooming device of claim 1, wherein the control switch is selected from a group consisting of a soft switch, push button switch, and a rotary switch.

10. The oral care and grooming device of claim 1, further comprising transmitting the usage details to a remote server for storing, processing, and analysis of the usage details.

11. The oral care and grooming device of claim 1, further comprising determining, by the microcontroller executing the algorithm, a need of servicing the oral care and grooming device based on the usage details and informing the user about the need of servicing of the oral care and grooming device.

12. An oral care and grooming system comprising:
a head section for connecting either a detachable oral care head or a detachable grooming head; and
a body comprising:
a power source connected to a microcontroller, a motor, and an indicating source,
wherein the microcontroller operates the motor and the communication device based on a position of a control switch,
wherein sensors present on the oral care and grooming device gathers raw usage data,
wherein an algorithm executed by the microcontroller determines usage details by processing the raw usage data, and wherein the usage details comprise date or time details, operation time, and an operation pattern of either the detachable oral care head or the detachable grooming head, whichever connected on the head section,
wherein the detachable oral care head and the detachable grooming head moves along with a movement of the motor,
and wherein the indicating source comprises either of a display device and an audio device to inform a user about the usage details.

13. The oral care and grooming system of claim 12, wherein the detachable grooming head comprises either of a trimmer, shaver, and epilator.

14. The oral care and grooming system of claim 12, further comprising the microcontroller determining, upon executing the algorithm, a need of replacement of the detachable oral care head.

15. The oral care system of claim 14, wherein the need of replacement of the detachable oral head is determined by the microcontroller upon executing the algorithm, wherein the algorithm uses one or more factors selected from a group consisting of a date of installation, time of installation, number of usage sessions, usage time per session, total usage time, pressure applied by a user upon usage of the detachable oral head, age and sex of the user, product details of the oral care system, and a type of the detachable oral head.

16. The oral care and grooming system of claim 12, further comprising the microcontroller determining upon executing the algorithm, a need of replacement of the detachable grooming head.

17. The oral care and grooming system of claim 16, wherein the need of replacement of the detachable grooming head is determined by the algorithm executed by the microcontroller, wherein the algorithm uses one or more factors selected from a group consisting of a date of installation, time of installation, number of usage sessions, usage time per session, total usage time, pressure applied by a user upon usage of the detachable oral head, age and sex of the user, product details of the oral care and grooming device, and a type of the detachable grooming head.

18. The oral care and grooming system of claim 12, further comprising informing the user, by an indicator, about the need of replacement of the detachable oral care head, wherein the indicator is at least one of a Light Emitting Diode (LED), Liquid Crystal Display (LCD), vibrating element, and a speaker.

19. The oral care and grooming system of claim 12, further comprising informing the user, by an indicator, about the need of replacement of the detachable grooming head, wherein the indicator is at least one of a Light Emitting Diode (LED), Liquid Crystal Display (LCD), vibrating element, and a speaker.

20. The oral care and grooming system of claim 12, wherein the control switch is selected from a group consisting of a soft switch, push button switch, and a rotary switch.

21. The oral care and grooming system of claim 14, further comprising transmitting the usage details to a remote server for storing, processing, and analysis of the usage details.

22. The oral care and grooming system of claim 12, further comprising determining, by the microcontroller executing the algorithm, a need of servicing the oral care and grooming system based on the usage details and informing the user about the need of servicing of the oral care and grooming system.

23. A method of using an oral care and grooming device, the method comprising:
connecting either a detachable oral care head or a detachable grooming head on a head section;
changing position of a control switch for operating, by a microcontroller, a motor and a communication device, wherein the detachable oral care head and the detachable grooming head moves along with a movement of the motor;
gathering, by sensors present on the oral care and grooming device, raw usage data;
determining, by an algorithm executed by a microcontroller, usage details by processing of the raw usage data, wherein the usage details comprise date or time details, operation time, and an operation pattern of either the detachable oral care head or the detachable grooming head, whichever connected on the head section; and
communicating, by a communication device, the usage details of the oral care and grooming device to a mobile application.

24. The method of claim 23, wherein the detachable grooming head comprises either of a trimmer, shaver, and epilator.

25. The method of claim 23, further comprising determining, by the microcontroller, a need of replacement of the detachable oral care head.

26. The method of claim 25, wherein the need of replacement of the detachable oral care head is determined based on one or more factors selected from a group consisting of a date of installation, time of installation, number of usage sessions, usage time per session, total usage time, pressure applied by a user upon usage of the detachable oral head, age and sex of the user, product details of the oral care and grooming device, and a type of the detachable oral care head.

27. The method of claim 25, further comprising determining a need of replacement of the detachable grooming head.

28. The method of claim 27, wherein the need of replacement of the detachable grooming head is determined based on one or more factors selected from a group consisting of a date of installation, time of installation, number of usage sessions, usage time per session, total usage time, pressure applied by a user upon usage of the detachable oral head, age and sex of the user, product details of the oral care and grooming device, and a type of the detachable grooming head.

29. The method of claim 23, further comprising informing, by an indicator, a user about a need of replacement of the detachable oral care, wherein the indicator is at least one of a Light Emitting Diode (LED), Liquid Crystal Display (LCD), vibrating element, and a speaker.

30. The method of claim 23, further comprising informing a user, by an indicator, about a need of replacement of the detachable grooming head, wherein the indicator is at least one of a Light Emitting Diode (LED), Liquid Crystal Display (LCD), vibrating element, and a speaker.

31. The method of claim 23, wherein the control switch is selected from a group consisting of a soft switch, push button switch, and a rotary switch.

32. The method of claim 23, further comprising determining, by the microcontroller executing the algorithm, a need of servicing of the oral care and grooming device based on the usage details and informing a user about the need of servicing of the oral care and grooming device.
